(19) United States
(12) Patent Application Publication
(10) Pub. No.: US 2025/0367861 A1
(43) Pub. Date: Dec. 4, 2025

(54) METHOD FOR PROCESSING SUBSTRATE

(71) Applicant: DISCO CORPORATION, Tokyo (JP)

(72) Inventor: Hiroshi ONODERA, Tokyo (JP)

(21) Appl. No.: 19/202,377

(22) Filed: May 8, 2025

(30) Foreign Application Priority Data
May 28, 2024 (JP) 2024-086589

(51) Int. Cl. B29C 41/12; B24B 7/20

(52) U.S. Cl. CPC B29C 41/12; B24B 7/20; B29K 2867/003

(57) ABSTRACT

A method for processing a substrate includes forming, in a state where the substrate and a film are integrated through a resin that cures due to an external stimulus, a laminate by semi-curing the resin by applying the external stimulus to the resin; processing the laminate; improving a curing degree of the resin by applying the external stimulus to the resin after processing of the laminate; and peeling the resin and the film from the substrate after improving of the curing degree.

### CROSS-REFERENCE TO RELATED APPLICATION(S)

The present application claims priority to and incorporates by reference the entire contents of Japanese Patent Application No. 2024-086589 filed in Japan on May 28, 2024.

### BACKGROUND

The present disclosure relates to a method for processing a substrate.

In the semiconductor wafer manufacturing process, as-sliced wafers are formed by slicing a cylindrical ingot with a wire saw.

This as-sliced wafer (wafer) has undulations and warping caused by the slicing process with a wire saw, and the undulations and warping are removed by grinding or the like.

In order to remove undulations and warping by grinding, a method is disclosed in which one surface side of the wafer is coated with resin to form a flat surface, and the other surface is ground using the formed flat surface as a reference surface (see, for example, JP 2011-151099 A).

In the method described in JP 2011-151099 A, liquid resin that is cured by the ultraviolet ray is supplied onto the film held on the holding table, one surface side of the wafer is brought into contact with the holding table to spread the liquid resin, and the liquid resin is irradiated with the ultraviolet ray while the liquid resin is spread on the one surface side of the wafer to cure the liquid resin, thereby coating the one surface side of the wafer with resin.

After that, the other surface side of the wafer is ground to planarize it, and then the resin and film are peeled off from the wafer.

However, in the method described in JP 2011-151099 A, warping may occur in the wafer due to shrinkage when the liquid resin is cured.

If warping occurs in the wafer, various problems may arise in the conveying step to the grinding device and the grinding step, which are the subsequent steps.

In addition, although a method to reduce warping by lowering the curing degree of the liquid resin can be considered, the fixing force between the resin and the film is reduced, so that there is a problem that when the resin and the film are peeled off from the wafer, the resin remains on the wafer, making it difficult to peel off.

### SUMMARY

A method for processing a substrate according to one aspect of the present disclosure includes forming, in a state where the substrate and a film are integrated through a resin that cures due to an external stimulus, a laminate by semi-curing the resin by applying the external stimulus to the resin; processing the laminate; improving a curing degree of the resin by applying the external stimulus to the resin after processing of the laminate; and peeling the resin and the film from the substrate after improving of the curing degree.

### BRIEF DESCRIPTION OF THE DRAWINGS

FIG. 1 is a cross-sectional view schematically illustrating a substrate to be processed in the method for processing the substrate according to the first embodiment;

FIG. 2 is a flow chart illustrating a flow of the method for processing the substrate according to the first embodiment;

FIG. 3 is a cross-sectional view schematically illustrating a state in which a resin that is cured by an external stimulus is placed on a film on a holding table in the laminate forming step in the method for processing the substrate illustrated in FIG. 2;

FIG. 4 is a diagram illustrating the relationship between the ultraviolet irradiation amount and the adhesion force of the liquid resin that is semi-cured in the laminate forming step in the method for processing the substrate illustrated in FIG. 2;

FIG. 5 is a cross-sectional view schematically illustrating a state in which one surface side of the substrate held on the lower surface of the holding unit is relative to the resin that is cured by an external stimulus on the film on the holding table in the laminate forming step in the method for processing the substrate illustrated in FIG. 2;

FIG. 6 is a cross-sectional view schematically illustrating a state in which one surface side of the substrate held on the lower surface of the holding unit is pressed against a resin that is cured by an external stimulus on the film on the holding table in the laminate forming step in the method for processing the substrate illustrated in FIG. 2;

FIG. 7 is a side view schematically illustrating the processing step in the method for processing the substrate illustrated in FIG. 2;

FIG. 8 is a cross-sectional view schematically illustrating the curing degree improving step in the method for processing the substrate illustrated in FIG. 2;

FIG. 9 is a side view schematically illustrating the laminate before the peeling step in the method for processing the substrate illustrated in FIG. 2;

FIG. 10 is a side view schematically illustrating the peeling step in the method for processing the substrate illustrated in FIG. 2; and

FIG. 11 is a side view schematically illustrating another surface side grinding step in the method for processing the substrate illustrated in FIG. 2.

### DETAILED DESCRIPTION

A form for implementing the present disclosure (an embodiment) will be described in detail with reference to the drawings. The present invention is not limited by the contents described in the following embodiment. In addition, the components described below include those that can be readily envisioned by one skilled in the art, and are substantially the same. Furthermore, the configurations described below can be suitably combined. In addition, various omissions, replacements or changes of the configuration can be made within the scope without departing from the spirit of the present invention.

### First Embodiment

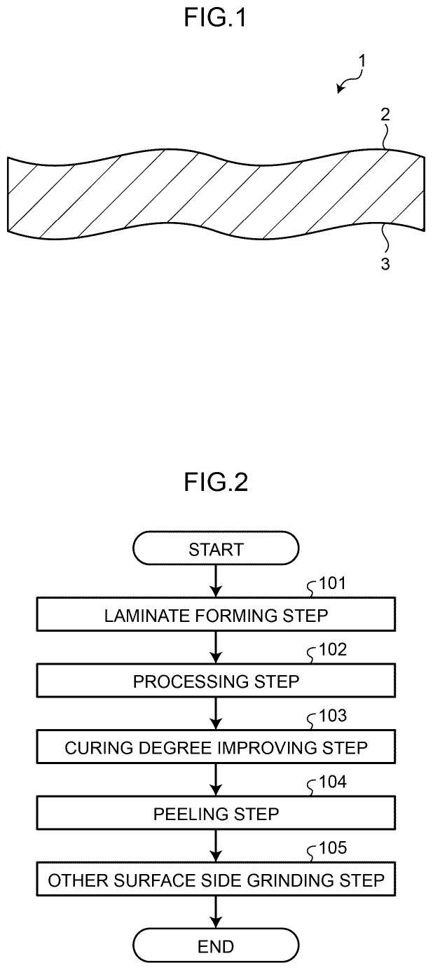

A method for processing a substrate according to the first embodiment of the present disclosure will be described based on the drawings. FIG. 1 is a cross-sectional view schematically illustrating a substrate to be processed in the method for processing the substrate according to the first embodiment. FIG. 2 is a flow chart illustrating the flow of the method for processing the substrate according to the first embodiment.

### Substrate

The method for processing the substrate according to the first embodiment is a method for processing a substrate 1 illustrated in FIG. 1. The substrate 1 to be processed in the method for processing the substrate according to the first embodiment is a so-called as-sliced wafer formed into a circular disk by being cut out at a predetermined thickness from a cylindrical ingot made of silicon, sapphire, gallium, SiC, or the like using a wire saw or the like.

As illustrated in FIG. 1, the substrate 1 according to the first embodiment has undulations formed on both the circular first surface 2 (corresponding to one surface) and the circular second surface 3 (corresponding to the other surface) on the rear side of the first surface 2. It should be noted that the undulation refers to the fact that both the first surface 2 and the second surface 3 are curved so that the thickness changes depending on the position of the substrate 1. In addition, in the first embodiment, the undulation occurs when the substrate 1 is cut out from the ingot by the wire saw mentioned above. It should be noted that FIG. 1 illustrates the undulations of the first surface 2 and second surface 3 in greater exaggeration than they actually are.

The method for processing the substrate according to the first embodiment is a method in which both the first surface 2 and the second surface 3 of the substrate 1 are formed flat, and the substrate 1 is thinned to a predetermined thickness. The method for processing the substrate according to the first embodiment includes a laminate forming step 101, a processing step 102, a curing degree improving step 103, a peeling step 104, and another surface side grinding step 105, as illustrated in FIG. 2.

### Laminate Forming Step

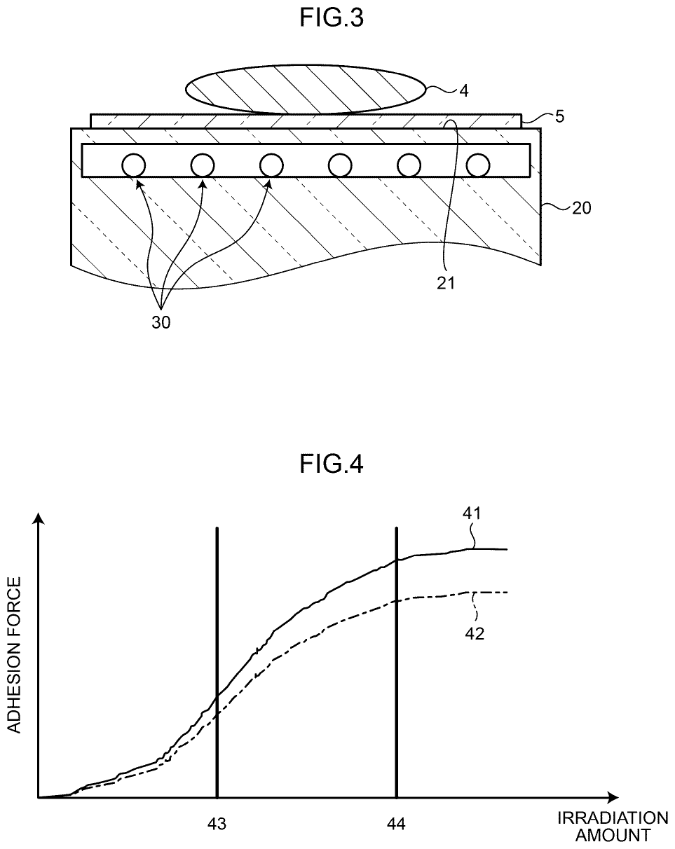

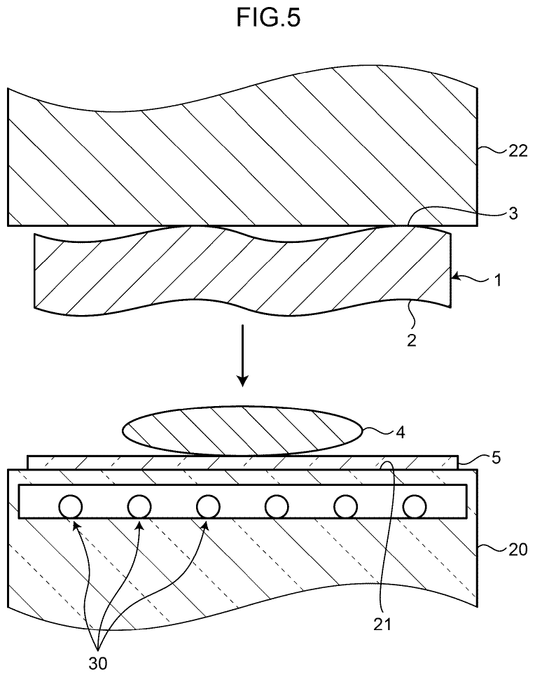

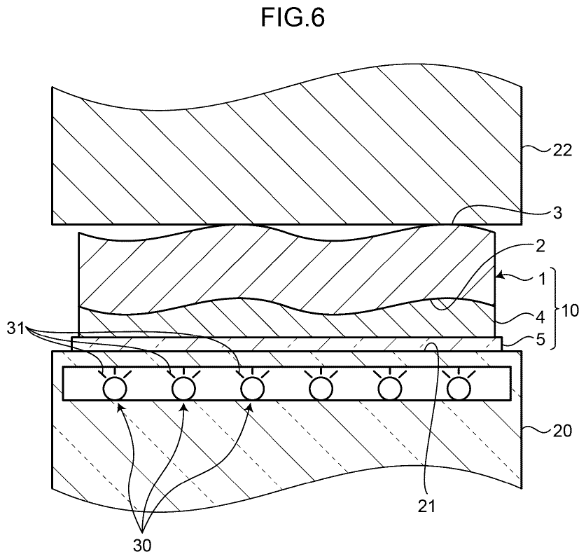

FIG. 3 is a cross-sectional view schematically illustrating a state in which a resin that is cured by an external stimulus is placed on a film on a holding table in the laminate forming step in the method for processing the substrate illustrated in FIG. 2. FIG. 4 is a diagram illustrating the relationship between the ultraviolet irradiation amount and the adhesion force of the liquid resin that is semi-cured in the laminate forming step in the method for processing the substrate illustrated in FIG. 2. FIG. 5 is a cross-sectional view schematically illustrating a state in which one surface side of the substrate held on the lower surface of the holding unit is relative to the resin that is cured by an external stimulus on the film on the holding table in the laminate forming step in the method for processing the substrate illustrated in FIG. 2. FIG. 6 is a cross-sectional view schematically illustrating a state in which one surface side of the substrate held on the lower surface of the holding unit is pressed against a resin that is cured by an external stimulus on the film on the holding table in the laminate forming step in the method for processing the substrate illustrated in FIG. 2.

The laminate forming step 101 is a step in which a laminate 10 (illustrated in FIG. 6) is obtained by applying the external stimulus to the resin 4 to semi-cure the resin 4 in a state in which the substrate 1 and the film 5 (illustrated in FIG. 3 and FIG. 5) are integrated through resin 4 (illustrated in FIG. 3 and FIG. 5) that is cured by an external stimulus. In the first embodiment, in the laminate forming step 101, as illustrated in FIG. 3, a circular disk-shaped film 5 having light transmittance and flexibility is placed on a flat holding surface 21 of a holding table 20 which is made of a light transmitting material such as glass, with a built-in ultraviolet ray irradiation lamp 30 that emits the ultraviolet ray 31 (illustrated in FIG. 6), which is an external stimulus. It should be noted that in the first embodiment, the film 5 is formed into a circular disk with a larger diameter than the substrate 1 and is made of PET (Polyethylene Terephthalate) resin.

In the first embodiment, in the laminate forming step 101, as illustrated in FIG. 3, a liquid resin 4 that is cured by an external stimulus is placed on the film 5 on the holding surface 21 of the holding table 20. In the first embodiment, the liquid resin 4 is a resin that crosslinks and cures when irradiated with the ultraviolet ray 31, which is an external stimulus, and does not soften even if external stimulus is applied after being cured. In addition, the curing degree (also called hardness) of the liquid resin 4 is improved as the irradiation amount of the ultraviolet ray 31 increases.

In addition, in the first embodiment, as illustrated in FIG. 4, as the irradiation amount of the ultraviolet ray 31 to the liquid resin 4 increases, the adhesion force 41 (indicated by solid lines in FIG. 4) with the film 5 is improved, and the adhesion force 42 (indicated by dotted lines in FIG. 4) with the substrate 1 is improved. It should be noted that the horizontal axis in FIG. 4 indicates the irradiation amount of the ultraviolet ray, and the vertical axis in FIG. 4 indicates the adhesion forces 41, 42). In addition, in the first embodiment, the liquid resin 4 has an adhesion force 41 with the film 5 higher than the adhesion force 42 with the substrate 1, and the difference between the adhesion force 41 with the film 5 and the adhesion force 42 with the substrate 1 increases as the irradiation amount of the ultraviolet ray 31 increases.

In the first embodiment, in the laminate forming step 101, as illustrated in FIG. 5, the first surface 2 of the substrate 1 in which the second surface 3 is suctioned and held by the flat lower surface of the holding unit 22 is opposed to the liquid resin 4 on the film 5 on the holding surface 21 of the holding table 20. In the first embodiment, in the laminate forming step 101, as illustrated in FIG. 6, the first surface 2 of the substrate 1, which has the second surface 3 suctioned and held against the flat lower surface of the holding unit 22, is pressed against the liquid resin 4 on the film 5 on the holding surface 21 of the holding table 20, and the liquid resin 4 is spread on the first surface 2 of the substrate 1, making the liquid resin 4 intimately contact with both the film 5 and the first surface 2 of the substrate 1.

In the first embodiment, in the laminate forming step 101, as illustrated in FIG. 6, the liquid resin 4, which is made intimately contact with both the film 5 on the holding surface 21 of the holding table 20 and the first surface 2 of the substrate 1, is irradiated with the ultraviolet ray 31 from an ultraviolet ray irradiation lamp 30 built in the holding table 20 through the holding table 20 and the film 5. In the first embodiment, in the laminate forming step 101, the liquid resin 4 is irradiated with the ultraviolet ray 31 with the first irradiation amount 43 (illustrated in FIG. 4) from the ultraviolet ray irradiation lamp 30.

It should be noted that in the first embodiment, the first irradiation amount 43 is an irradiation amount such that when the first irradiation amount 43 or more of the ultraviolet ray 31 is applied, the liquid resin 4 is semi-cured, the amount of variation in the thickness of the resin 4 in the processing step 102 becomes less than or equal to a predetermined value, and the second surface 3 of the substrate 1 can be ground to planarize the second surface 3. That is, the first irradiation amount 43 is an irradiation amount of the ultraviolet ray 31 that allow the liquid resin 4 to be semi-cured so that the second surface 3 of the substrate 1 can be planarized by grinding, and the semi-curing means that the amount of variation in the thickness of the resin 4 in the processing step 102 becomes less than or equal to a predetermined value, and the liquid resin 4 is cured to such a degree that the second surface 3 can be planarized by grinding the second surface 3 of the substrate 1.

Thus, in the first embodiment, in the laminate forming step 101, the liquid resin 4 which is intimately contact with both the film 5 and the first surface 2 of the substrate 1 is semi-cured to obtain a laminate 10 in which the film 5, the substrate 1, and the resin 4 are integrated. In this way, in the first embodiment, in the laminate forming step 101, liquid resin 4 is supplied onto one surface side of the film 5, the first surface 2 side of the substrate 1 is pressed against the film 5 onto which the resin 4 is supplied, and the resin 4 is semi-cured in a state where the resin 4 is spread on the first surface 2 side of the substrate 1.

It should be noted that in the first embodiment, as the liquid resin 4, a UV curable resin that is cured when irradiated with the ultraviolet ray 31, which is an external stimulus, is used, but in the present disclosure, a thermosetting resin that is cured when heated, which is an external stimulus, may also be used. In addition, in the laminate forming step 101 in the present disclosure, the irradiation amount of the ultraviolet ray 31 to irradiate the liquid resin 4 which is intimately contact with both the film 5 and the first surface 2 of the substrate 1 may be set to be an irradiation amount of the first irradiation amount 43 or more and less than a second irradiation amount 44, which will be described later.

### Processing Step

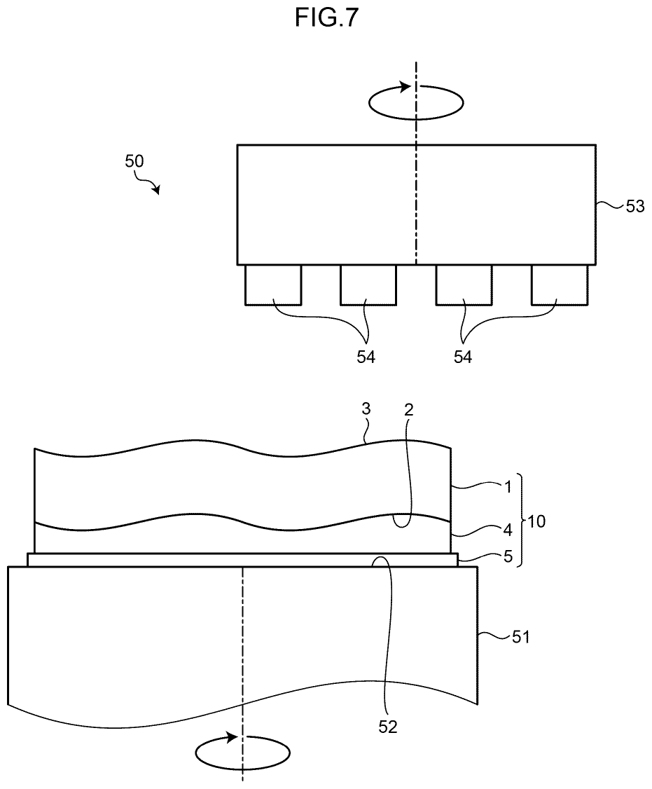

FIG. 7 is a side view schematically illustrating the processing step of the method for processing the substrate illustrated in FIG. 2. The processing step 102 is a step of processing the laminate 10. In the first embodiment, for the processing in the processing step 102, the second surface 3 side of the substrate 1 in the laminate 10 is ground.

In the first embodiment, in the processing step 102, the grinding device 50 illustrated in FIG. 7 suctions and holds the first surface 2 side of the substrate 1 on the holding surface 52 of the holding table 51 via the film 5 and the semi-cured resin 4. In the first embodiment, in the processing step 102, as illustrated in FIG. 7, while the grinding device 50 rotates the grinding wheel 53 around an axis by a spindle (not illustrated), and rotates the holding table 51 around an axis, the grinding device 50 supplies grinding fluid, and also brings the grinding wheel 54 closer to the holding table 51 at a prescribed feeding speed so as to make the grinding wheel 54 abut against the second surface 3 of the substrate 1, thereby grinding the entire surface of the second surface 3 of the substrate 1 with the grinding wheel 54, and planarizing the second surface 3.

### Curing Degree Improving Step

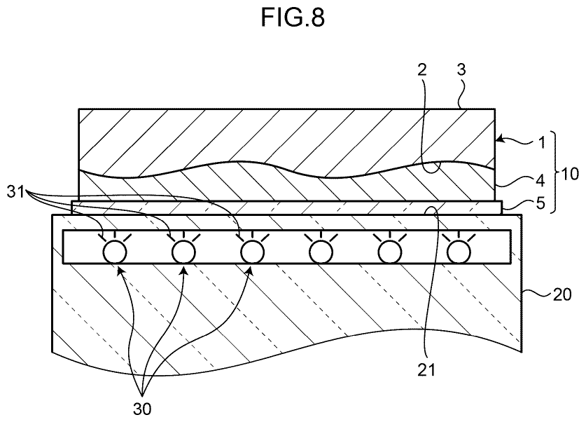

FIG. 8 is a cross-sectional view schematically illustrating the curing degree improving step in the method for processing the substrate illustrated in FIG. 2. The curing degree improving step 103 is a step in which, after the processing step 102, the curing degree of the resin 4 is improved by applying the ultraviolet ray 31, which is an external stimulus, to the resin 4.

In the first embodiment, in the curing degree improving step 103, as illustrated in FIG. 8, the first surface 2 of the substrate 1 is placed on the flat holding surface 21 of the holding table 20 via the film 5 and the resin 4. In the first embodiment, in the curing degree improving step 103, as illustrated in FIG. 8, the resin 4, which is made intimately contact with both the film 5 on the holding surface 21 of the holding table 20 and the first surface 2 of the substrate 1, is irradiated with the ultraviolet ray 31 from the ultraviolet ray irradiation lamp 30 built in the holding table 20 through the holding table 20 and the film 5.

In the first embodiment, in the curing degree improving step 103, the resin 4 is irradiated with the ultraviolet ray 31 in which the accumulated irradiation amount from the laminate forming step 101 of the ultraviolet ray 31 with which the resin 4 is irradiated from the ultraviolet ray irradiation lamp 30 is a second irradiation amount 44 (illustrated in FIG. 4). It should be noted that in the first embodiment, the second irradiation amount 44 is more than the first irradiation amount 43 in terms of the irradiation amount of the ultraviolet ray 31, and is an irradiation amount such that when the film 5 is peeled from the first surface 2 of the substrate 1 after being irradiated with the ultraviolet ray 31 at the second irradiation amount 44 or more, the resin 4 can be peeled from the first surface 2 of the substrate 1 together with the film 5 without remaining on the first surface 2 of the substrate 1.

That is, if the resin 4 is irradiated with the ultraviolet ray 31 of an irradiation amount of the first irradiation amount 43 or more and less than the second irradiation amount 44, when the film 5 is peeled off from the first surface 2 of the substrate 1, a part of the resin 4 remains on the first surface 2 of the substrate 1, and the rest of the resin 4 together with the film 5 is peeled off from the first surface 2 of the substrate 1. In this way, in the first embodiment, in the curing degree improving step 103, the curing degree of the resin 4 which is intimately contact with both the film 5 and the first surface 2 of the substrate 1 is improved. In addition, in the present disclosure, in the curing degree improving step 103, the accumulated irradiation amount from the laminate forming step 101 of the ultraviolet ray 31 with which the resin 4 which is intimately contact with both the film 5 and the first surface 2 of the substrate 1 is irradiated may be an irradiation amount of the second irradiation amount 44 or more.

### Peeling Step

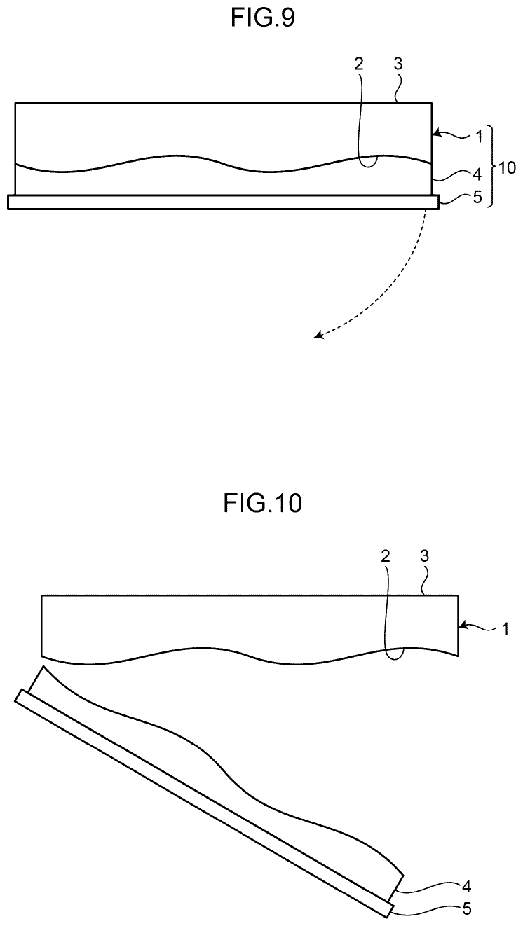

FIG. 9 is a side view schematically illustrating the laminate before the peeling step in the method for processing the substrate illustrated in FIG. 2. FIG. 10 is a side view schematically illustrating the peeling step in the method for processing the substrate illustrated in FIG. 2. The peeling step 104 is a step of peeling the resin 4 and the film 5 from the substrate 1 after the curing degree improving step 103.

In the first embodiment, in the peeling step 104, only the film 5 is peeled off from the laminate 10 illustrated in FIG. 9 after the curing degree improving step 103. In the curing degree improving step 103, the resin 4 is irradiated with the ultraviolet ray 31 of the second irradiation amount 44, so that in the peeling step 104, all of the resin 4 together with the film 5 are peeled off from the first surface 2 of the substrate 1, as illustrated in FIG. 10. It should be noted that in the first embodiment, in the peeling step 104, the film 5 is peeled off from the first surface 2 of the substrate 1 so that using one end of the film 5 as a pivot, the other end is moved away from the first surface 2 of the substrate 1.

### Another Surface Side Grinding Step

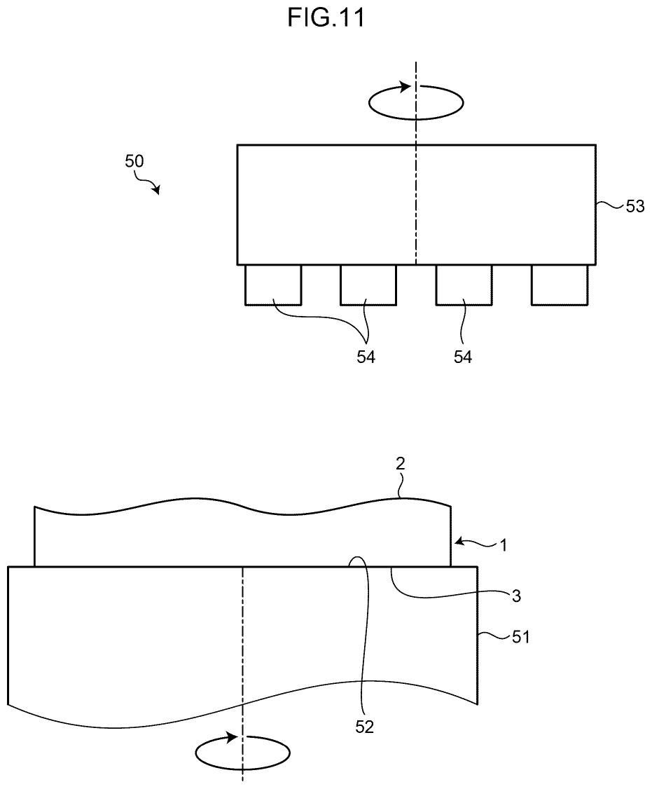

FIG. 11 is a side view schematically illustrating another surface side grinding step in the method for processing the substrate illustrated in FIG. 2. The other surface side grinding step 105 is a step of grinding the first surface 2 side of the substrate 1.

In the first embodiment, in the other surface side grinding step 105, the grinding device 50 illustrated in FIG. 11 suctions and holds the planarized second surface 3 side of the substrate 1 on the holding surface 52 of the holding table 51. In the first embodiment, in the other surface side grinding step 105, as illustrated in FIG. 11, while the grinding device 50 rotates the grinding wheel 53 about an axis and rotates the holding table 51 around an axis by spindles (not illustrated), the grinding fluid is supplied, and by causing the grinding wheel 54 to abut against the first surface 2 of the substrate 1 and come close to the holding table 51 at a predetermined feeding speed, the entire surface of the first surface 2 of the substrate 1 is ground with the grinding wheel 54 to planarize the first surface 2 and thin the substrate 1 to a predetermined thickness.

The above-described method for processing a substrate according to the first embodiment includes: a laminate forming step 101 of, in a state where the substrate 1 and a film 5 are integrated through a liquid resin 4 that cures due to an external stimulus, obtaining a laminate 10 by semi-curing the resin 4; a processing step 102 of processing, i.e., grinding the laminate 10; a curing degree improving step 103 of improving a curing degree of the resin 4 by applying the external stimulus to the resin 4 after the processing step 102; and a peeling step 104 of peeling the resin 4 and the film 5 from the substrate 1 after the curing degree improving step 103.

For that reason, in the method for processing the substrate according to the first embodiment, since the liquid resin 4 is semi-cured in the laminate forming step 101, the shrinkage of the resin 4 in the laminate forming step 101 can be suppressed, and warping that occurs on the substrate 1 when the substrate 1 is covered with the resin 4 can be reduced.

As a result, the method for processing the substrate according to the first embodiment reduces the warping that occurs on the substrate 1 when the substrate 1 is coated with resin 4, and thus the effect that the possibility of a problem occurring in the subsequent steps due to warping is reduced, and the resin 4 can be easily peeled off from the substrate 1 is exerted.

According to the present disclosure, by reducing warping that occurs on the substrate when the substrate is coated with resin, the possibility of problems occurring in subsequent steps as a result of warping is reduced, and the resin can be easily peeled off from the substrate.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method for processing a substrate, the method comprising:
forming, in a state where the substrate and a film are integrated through a resin that cures due to an external stimulus, a laminate by semi-curing the resin by applying the external stimulus to the resin;
processing the laminate;
improving a curing degree of the resin by applying the external stimulus to the resin after processing of the laminate; and
peeling the resin and the film from the substrate after improving of the curing degree.

2. The method for processing the substrate according to claim 1, wherein processing of the laminate includes grinding a side of the substrate in the laminate.

3. The method for processing the substrate according to claim 1, wherein forming of the laminate includes
supplying the resin onto one surface side of the film, pressing one surface side of the substrate against the film onto which the resin has been supplied, and semi-curing the resin in a state where the resin is spread on the one surface side of the substrate.
